(19) United States
(12) Patent Application Publication
(10) Pub. No.: US 2006/0119459 A1
(43) Pub. Date: Jun. 8, 2006

(54) Ignition coil with case made from impregnated mica tube

(76) Inventors: Albert Anthony Skinner, El Paso, TX (US); Mark Albert Paul, El Paso, TX (US); Kenneth P. Senseman, Noblesville, IN (US); James Patrick Henry, Fairport, NY (US)

Correspondence Address: JIMMY L. FUNKE;DELPHI TECHNOLOGIES, INC., Mail Code: 480-410-202, P.O. Box 5052, Troy, MI, 48007-5052, US

(21) Appl. No.: 11/006,037

(22) Filed: Dec. 7, 2004

(51) Int. Cl. H01F 27/02

(52) U.S. Cl. 336/96

(57) ABSTRACT

An ignition coil assembly includes a cylindrical central core having a main axis, a primary winding outwardly of the central core, a secondary winding outwardly of the primary winding, and a case having a first tube formed of a material having mica dispersed in a binder. The binder is may be a silicone-based binder, an epoxy-based binder or any other binder configured to adhere to the mica. The overall diameter of the ignition coil assembly can reduced relative to conventional designs since the case thickness can be reduced over known designs.

### TECHNICAL FIELD

The present invention relates generally to ignition coils for developing a spark firing voltage that is applied to one or more spark plugs of an internal combustion engine and more particularly to an ignition coil with a case made from an impregnated mica tube.

### DESCRIPTION OF THE RELATED ART

U.S. Pat. No. 6,463,919 issued to Skinner et al. entitled “IGNITION COIL WITH POLYIMIDE CASE AND/OR SECONDARY SPOOL” discloses an ignition coil having a relatively slender configuration adapted for mounting directly above the spark plug—commonly referred to as a “pencil” coil. A pencil coil design with the secondary winding wound external to (i.e., radially outwardly of) the primary winding and that has the shield(s) located external to the case yields an increased energy-delivery capability ignition coil, as compared to one where the primary winding is wound external to the secondary winding. This is because the primary winding can be wound onto the core thereby eliminating the primary spool and allowing for a larger core. This construction, however, puts a high dielectric stress on the case. The patent to Skinner et al. disclose an ignition coil having a case comprising polyimide material. Polyimide material, while exhibiting an improved resistance to dielectric stress, only exhibits a predetermined stiffness during high temperature operation and/or testing (e.g., during manufacture during a potting stage of assembly, or during in-service operation). It would be desired to provide increased stiffness, for example, to improve dimensional tolerances over temperature.

There is therefore a need for an improved ignition coil assembly that minimizes or eliminates one or more of the problems set forth above.

### SUMMARY OF THE INVENTION

One advantage of an ignition coil assembly according to the invention is that it provides a smaller coil design with respect to overall outside diameter. Another advantage of the present invention is that it provides a lower cost ignition coil by allowing a larger central core of either a reduced cost steel (e.g., M-27 instead of M-6, as is conventionally used for a central core) or, alternatively, by allowing one or more permanent magnets to be removed (i.e., maintain the same performance by providing a larger core, thereby allowing removal of the one or more permanent magnets). Another advantage of a case being formed using a mica impregnated tube is that it provides improved dimensional stability, for example, over temperature variation (e.g., during potting or operation).

These and other advantages, features and objects are realized by a case comprising a mica impregnated material (e.g., mica dispersed in a silicone-based binder or an epoxy-based binder).

An ignition coil assembly according to the invention includes a central core, a primary winding, a secondary winding, and a case. The central core is generally cylindrical and is formed along a main axis. The primary winding is disposed about the central core and is connected to a power source. The secondary winding is wound on a spool that is configured to be connected to a spark plug. The secondary winding is located radially outwardly of the primary winding. The case is located radially outwardly of the secondary winding and comprises a tube comprising mica impregnated in a suitable binder, such as a silicone-based binder, an epoxy-based binder, or other binder of a material that adheres to the mica in order to form a rigid tube capable of withstanding temperature variations encountered by an ignition coil during manufacture and subsequent operation.

### BRIEF DESCRIPTION OF THE DRAWINGS

The present invention will now be described by way of example, with reference to the accompanying drawings.

FIG. 1 is a simplified, cross-section view of an ignition coil in accordance with the present invention.

FIG. 2 is a top view of the case.

### DETAILED DESCRIPTION OF THE PREFERRED EMBODIMENT

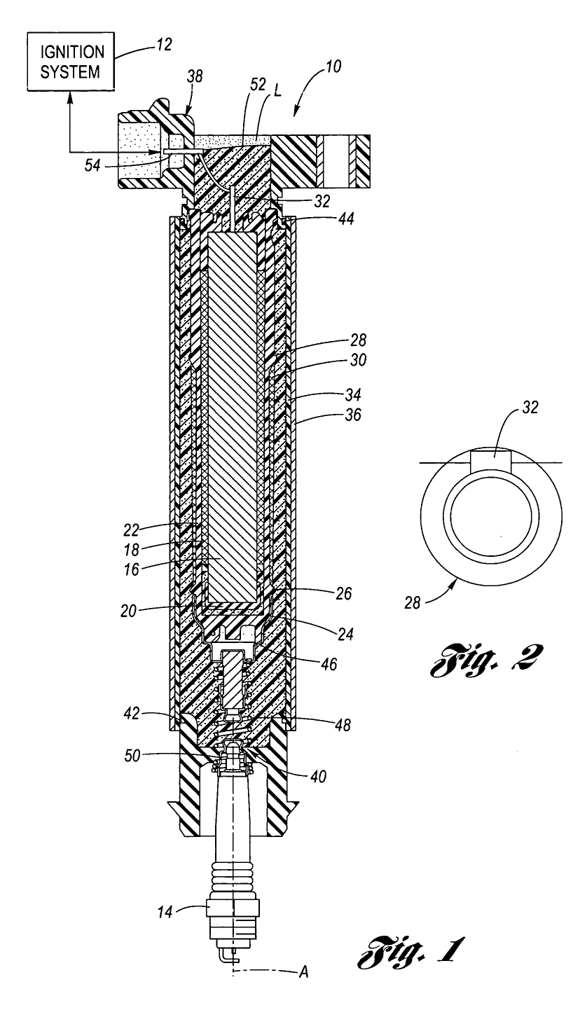

Referring now to the drawings wherein like reference numerals are used to identify identical components in the various views, FIG. 1 is a simplified, cross-section view of an ignition coil 10 in accordance with the present invention. As is generally known, ignition coil 10 may be coupled to, for example, an ignition system 12, which may contain circuitry for controlling the charging and discharging of ignition coil 10. Further, also as is well known, the relatively high voltage produced by ignition coil 10 is provided to a spark plug 14 for producing a spark across a spark gap thereof, which may be employed to initiate combustion in a combustion chamber of an engine. Ignition system 12 and spark plug 14 perform conventional functions well known to those of ordinary skill in the art.

Ignition coil 10 is adapted for installation to a conventional internal combustion engine through a spark plug well onto a high-voltage terminal of spark plug 14, which may be retained by a threaded engagement with a spark plug opening into the above-described combustion cylinder. Ignition coil 10 comprises a substantially slender high voltage transformer including substantially, coaxially arranged primary and secondary windings and a high permeability magnetic core.

Referring to FIG. 1, in accordance with the invention, ignition coil 10 includes a core 16, a primary winding 18, a rubber core buffer 20, a secondary winding spool 22 having a first end 24 with a first winding flange 26 and a second winding flange 28, a secondary winding 30, a low-voltage terminal 32 (best shown in FIG. 2), a case (tube) 34, a magnetically-permeable side core or shield 36, a low-voltage (LV) connector assembly 38, and a high-voltage (HV) connector assembly 40.

FIG. 1 further shows a first O-ring 42, a second O-ring 44, a high-voltage (HV) terminal 46, and electrical connectors such as a spring 48, a spark plug HV terminal connector 50, encapsulant such as epoxy potting material 52, and a plurality of low voltage pin terminals 54.

Core 16 may be elongated, having a main, longitudinal axis designated “A” associated therewith. Core 16 comprises magnetically permeable material, for example, a plurality silicon steel laminations (not shown); however, core 16 may alternatively comprise a compression molded item comprising insulated iron particles, as known. Core 16 may therefore be a conventional core known to those of ordinary skill in the art. Core 16, in the preferred embodiment, takes a generally cylindrical shape (which is a generally circular shape in radial cross-section).

The space saved by a case comprising impregnated mica material may (1) allow for a smaller ignition coil, or (2) provide for a higher energy delivery capability ignition coil in the same package size due to being able to allocate addition core volume and/or copper volume (e.g., for windings). This additional core/copper produces an improved magnetic circuit, and thus, improved performance of ignition coil 10, all other factors being the same. Finally, the capability of providing more core volume yields more options as to the type of core material to meet a particular design specification. Additionally, this invention can reduce cost by providing the option of eliminating magnets on the top/bottom of the central core that are sometimes used in a conventional arrangement.

Referring again to FIG. 1, primary winding 18, as shown, is wound directly onto core 16. Primary winding 18 includes first and second ends (not shown) and is configured to carry a primary current I_{P} for charging coil 10 upon control of ignition system 12. Winding 18 may be implemented using known approaches and conventional materials.

Secondary winding spool 22 is configured to receive and retain secondary winding 30. Spool 22 is disposed adjacent to and radially outwardly of the central components comprising core 16, primary winding 18, and the epoxy potting material, and, preferably, is in coaxial relationship therewith. Spool 22 may comprise any one of a number of conventional spool configurations known to those of ordinary skill in the art. In the illustrated embodiment, spool 22 is configured to receive one continuous secondary winding (e.g., progressive winding) on an outer winding surface thereof, between upper and lower flanges 28 and 26 (defining a “winding bay”), as is known. However, it should be understood that other configurations may be employed, such as, for example only, a configuration adapted for use with a segmented winding strategy (e.g., a spool of the type having a plurality of axially spaced ribs forming a plurality of channels therebetween for accepting windings), as known.

The depth of the secondary winding in the illustrated embodiment may decrease from the top of spool 22 (i.e., near the upper end of core 16), to the other end of spool 22 (i.e., near the lower end) by way of a progressive gradual flare of the spool body. The result of the flare or taper is to increase the radial distance (i.e., taken with respect to axis “A”) between primary winding 18 and secondary winding 30, progressively, from the top to the bottom. As is known in the art, the voltage gradient in the axial direction, which increases toward the spark plug end (i.e., high voltage end) of the secondary winding, may require increased dielectric insulation between the secondary and primary windings, and, may be provided for by way of the progressively increased separation between the secondary and primary windings.

Spool 22 may be formed generally of electrical insulating material having properties suitable for use in a relatively high temperature environment. For example, spool 22 may comprise plastic material such as polyphenylene oxide or polystyrene PPO/PS (e.g., NORYL® IGN320 available from General Electric, New York, N.Y. USA) or polybutylene terephthalate (PBT) thermoplastic polyester. It should be understood that there are a variety of alternative materials that may be used for spool 22 known to those of ordinary skill in the ignition art, the foregoing being exemplary only and not limiting in nature.

Features 26 and 28 may be annular in shape and be further configured so as to engage an inner surface of case 34 to locate, align, and center the spool 22 in the cavity of case 34 and providing upper and lower defining features for a winding surface therebetween.

As shown in FIG. 2, flange 28 is also generally annular in shape. FIG. 2 shows a top view of a low-voltage terminal 32, to be described below.

As described above, spool 22 has associated therewith an electrically conductive (i.e., metal) high-voltage (HV) terminal 46 disposed therein configured to engage a conductive cup, which cup is in turn electrically connected to the HV connector assembly 40. The body of spool 22 at a lower end thereof is configured so as to be press-fit into the interior of the cup (i.e., the spool gate portion).

FIG. 1 shows secondary winding 30. Winding 30 may be wound onto spool 22, as known. In the illustrated embodiment, spool 22 is configured to receive one continuous secondary winding (e.g., progressive winding), as is known. The low voltage end may be connected to ground by way of a ground connection through LV connector body 38 by way of LV terminal 32, as described above. The high voltage end may be connected to spark plug contact 50 via high-voltage (HV) terminal 46 and spring 48 for electrically connecting the high voltage generated by secondary winding 30 to spark plug 14. Other arrangements for establishing such a connection will be recognized by those of ordinary skill in the art, and are within the spirit and scope of the present invention. As known, an interruption of a primary current Ip through primary winding 18, as controlled by ignition system 12, is operative to produce a high voltage at the high voltage end of secondary winding 30. Winding 30 may otherwise be implemented using conventional approaches and material known to those of ordinary skill in the art.

FIG. 1 shows a cross-sectional, enlarged view of case 34. Case 34 is generally cylindrical and includes inner and outer surfaces. The inner surface is configured in size to receive and retain the subassembly comprising core 16/primary winding 18/secondary winding spool 22/secondary winding 30.

In accordance with the present invention, case 34 comprises mica material dispersed in a binder, formed as a tube. The tube 34 includes a first opening (top) and a second opening (bottom) axially opposite the first opening. The top opening of case 34 is sealed by low-voltage (LV) connector assembly 38, which may be formed using conventional thermoplastic material, such as thermoplastic polyester resin (e.g., Rynite® RE5220 available from E. I. Du Pont De Nemours and Company Wilmington Del. USA). O-ring 42 or the like is configured to seal between the LV connector assembly 38 and the inside diameter surface of tube 34. Likewise, the bottom opening is sealed by HV connector assembly 40, which may also be formed using conventional thermoplastic materials such as thermoplastic polyester resin (e.g., Rynite® RE5220 available from E. I. Du Pont De Nemours and Company Wilmington Del. USA). O-ring 44 or the like is configured to seal the HV connector assembly 40 and the ID surface of tube 34. Tube 34 comprises material made using mica powder and/or mica flakes that are dispersed in and are held together with a suitable binder. The binder may be a silicone-based binder, an epoxy-based binder, or any other material that adheres to mica that can form a rigid tube 34 capable of withstanding the build and potting process of an ignition coil 10. For example, for a known potting process that includes dwell, cure and cool down stages, the ignition coil and thus case 34 as well may experience temperatures up to 120° C. or possibly more for extended periods of time (e.g., an hour or more). The case 34 (tube) should be able to maintain or approximate predetermined stiffness level(s) during this process. The mica material is robust to partial discharge, but is difficult to directly mold into a standard case configuration, so a standard tube shape is used in the present invention.

In one embodiment, tube 34 comprises a commercial product made available under the trademark VITRA-BOND tube by Von Roll Isola USA, Inc., Schenectady, N.Y. 12306 USA.

One advantage of tube 34 is that it provides a case capable of withstanding the high electric fields (E-fields) (e.g., >15 kvolts) expected during the service life of ignition coil 10. Another advantage is that it can be made having a thickness in the range of between about 0.15 mm and 0.50 mm. This reduced thickness case would replace a case produced using conventionally-employed materials that is typically about 1.2 mm thick. The space savings would allow for either a smaller overall ignition coil, an increased output due to an increased core (that would be available in the same space), or a reduced cost by eliminating magnets (e.g., a permanent magnet disposed at one or more end surfaces of core 16) that would otherwise be required to obtain a desired output level (i.e., magnets not needed because the core and/or windings can be increased).

FIG. 1 further shows a cross-sectional, exaggerated view of shield 36. Shield 36 is generally annular in shape and is disposed radially outwardly of case 34, and, preferably, engages outer surface of case 34. Shield 36 comprises electrically conductive material, and, preferably, metal, such as steel or other adequate magnetic material. Shield 36 provides not only a protective barrier for ignition coil 10 generally, but, further, provides a magnetic path for the magnetic circuit portion of ignition coil 10. Shield 36 may nominally be about 0.50 mm thick, in one embodiment. Shield 36 may be grounded by way of an internal grounding strap, finger or the like (not shown) well know to those of ordinary skill in the art.

Low voltage connector body 38 is configured to, among other things, electrically connect the first and second ends of primary winding 18 to an energization source, such as, the energization circuitry included in ignition system 12. Connector body 38 is generally formed of electrical insulating material, but also includes a plurality of electrically conductive output terminals 54 (e.g., pins for ground, primary winding leads, etc.). Terminals 54 are coupled electrically, internally through connector body 38, in a manner known to those of ordinary skill in the art, and are thereafter connected to various parts of coil 10, also in a manner generally know to those of ordinary skill in the art. Ignition system 12 may then control energization of the primary winding 18.

FIG. 1 further shows a cross-sectional view, with portions broken away, of HV connector assembly 40. HV connector assembly 40 may include a spring connection 48 or the like, which is electrically coupled between HV terminal 46 and contact 50. HV terminal 46 is in turn coupled to the high voltage lead of secondary winding 30. Contact 50 is configured to engage a high-voltage connector terminal of spark plug 14. This arrangement for coupling the high voltage developed by secondary winding 30 to plug 14 is exemplary only; a number of alternative connector arrangements, particularly spring-biased arrangements, are known in the art.

The potting material 52 may be introduced into potting channels defined (i) between primary winding 18 and secondary winding spool 22, and (ii) between secondary winding 30 and case 34. The potting channels are filled with potting material, in the illustrated embodiment, up to approximately the level designated “L” in FIG. 1. The potting material performs the function of electrical insulation and, provides protection from environmental factors which may be encountered during the service life of ignition coil 10. There are a number of suitable epoxy potting materials well known to those of ordinary skill in the art.

1. An ignition coil assembly comprising
a central core having a main axis;
a primary winding disposed about said core that is configured to be connected to a power source;
a secondary winding wound on a spool that is configured to be connected to a spark plug, said secondary winding being disposed outwardly of said primary winding; and
a case radially outwardly of said secondary winding, said case having a first tube formed of a material having mica dispersed in a binder selected from the group comprising a silicone-based binder, an epoxy-based binder and an adherent binder configured to adhere to said mica.

2. The assembly of claim 1 wherein said spool comprises a second tube formed of said material.

3. The assembly of claim 1 further comprising a magnetically-permeable shield disposed outwardly of said case.

4. The assembly of claim 3 wherein said primary winding is wound directly on said central core.

5. The assembly of claim 4 further comprising a high-voltage (HV) connector assembly configured to seal a first end opening of said first tube.

6. The assembly of claim 5 further comprising an O-ring between said first tube and said HV connector assembly.

7. The assembly of claim 5 wherein said HV connector assembly comprises thermoplastic polyester resin material.

8. The assembly of claim 4 further comprising a low-voltage (LV) connector assembly configured to seal a second end opening of said first tube opposite said first end opening.

9. The assembly of claim 8 further comprising an O-ring intermediate said first tube and said LV connector assembly.

10. The assembly of claim 1 wherein said first tube is between about 0.15 and 0.50 mm thick.

11. The assembly of claim 10 wherein said first tube is between about 0.15 and 0.20 mm thick.

12. The assembly of claim 1 wherein said first tube is extruded.

13. The assembly of claim 1 wherein said mica comprises one of mica flakes and mica powder.
